(19) United States
(12) Patent Application Publication
(10) Pub. No.: US 2022/0012542 A1
(43) Pub. Date: Jan. 13, 2022

(54) BANDIT-BASED TECHNIQUES FOR FAIRNESS-AWARE HYPERPARAMETER OPTIMIZATION

(71) Applicant: Feedzai-Consultadoria e Inovacão Tecnológica, S.A., Coimbra (PT)

(72) Inventors: André Miguel Ferreira da Cruz, Vila do Conde (PT); Pedro dos Santos Saleiro, Lisbon (PT); Pedro Gustavo Santos Rodrigues Bizarro, Lisbon (PT); Carlos Manuel Milheiro de Oliveira Pinto Soares, Porto (PT)

(21) Appl. No.: 17/370,747

(22) Filed: Jul. 8, 2021

Related U.S. Application Data
(60) Provisional application No. 63/050,520, filed on Jul. 10, 2020.

(30) Foreign Application Priority Data
Jul. 2, 2021 (EP) 21183473.4
Jul. 2, 2021 (PT) 117323

(51) Int. Cl. G06K 9/62; G06N 20/00

(52) U.S. Cl. CPC G06K 9/6262; G06N 20/00; G06K 9/6256

(57) ABSTRACT

In various embodiments, a process for fairness-aware hyperparameter optimization based on bandit-based techniques includes receiving a fairness evaluation metric for evaluating a fairness of a machine learning model to be trained and receiving a performance metric for evaluating performance of the machine learning model to be trained. The process includes automatically evaluating candidate combinations of hyperparameters of the machine learning model based at least in part on multi-objective optimization including scalarization and using the fairness evaluation metric and the performance metric to select a hyperparameter combination to utilize among the candidate combinations of hyperparameters, wherein evaluating the candidate combinations of hyperparameters of the machine learning model includes automatically and dynamically determining a relative weighting between the fairness evaluation metric and the performance metric. The process includes using the selected hyperparameter combination to train the machine learning model.

### CROSS REFERENCE TO OTHER APPLICATIONS

This application claims priority to U.S. Provisional Patent Application No. 63/050,520 entitled BANDIT-BASED TECHNIQUES FOR FAIRNESS-AWARE HYPERPARAMETER OPTIMIZATION filed July 10, 2020 which is incorporated herein by reference for all purposes.

This application claims priority to Portugal Provisional Patent Application No. 117323 entitled BANDIT-BASED TECHNIQUES FOR FAIRNESS-AWARE HYPERPARAMETER OPTIMIZATION filed July 2, 2021 which is incorporated herein by reference for all purposes.

This application claims priority to European Patent Application No. 21183473.4 entitled BANDIT-BASED TECHNIQUES FOR FAIRNESS-AWARE HYPERPARAMETER OPTIMIZATION filed July 2, 2021 which is incorporated herein by reference for all purposes.

### BACKGROUND OF THE INVENTION

Artificial intelligence, including machine learning, is becoming increasingly used in or integrated into computer programs. Algorithmic bias arises when a machine learning model displays disparate predictive and error rates across sub-groups of the population, hurting individuals based on ethnicity, age, gender, or any other sensitive attribute. This may have various causes such as historical biases encoded in the data, misrepresented populations in data samples, noisy labels, development decisions, or simply the nature of learning under severe class-imbalance. Algorithmic fairness is an emerging field aimed at studying and mitigating discrimination in the decision-making process across protected sub-groups.

### BRIEF DESCRIPTION OF THE DRAWINGS

Various embodiments of the invention are disclosed in the following detailed description and the accompanying drawings.

FIG. 1 illustrates an example of machine learning models and their associated fairness and performance.

FIG. 2 is a flow diagram illustrating an embodiment of a process for fairness-aware hyperparameter optimization based on bandit-based techniques.

FIG. 3 is a block diagram illustrating an embodiment of a system for bandit-based techniques for fairness-aware hyperparameter optimization.

FIG. 4 shows an example of hyperparameters used for a Random Forest model.

FIG. 5 shows an example of hyperparameters used for a LightGBM model.

FIG. 6 shows an example of hyperparameters used for a Decision Tree model.

FIG. 7 shows an example of hyperparameters used for a Logistic Regression model.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Despite recent developments in algorithmic fairness, conventional techniques lack practical methodologies and tools to seamlessly integrate fairness objectives or bias reduction techniques in existing real-world machine learning pipelines. Existing bias reduction techniques typically target only specific stages of the machine learning pipeline (e.g., data sampling, model training), and often only apply to a single fairness definition or family of models.

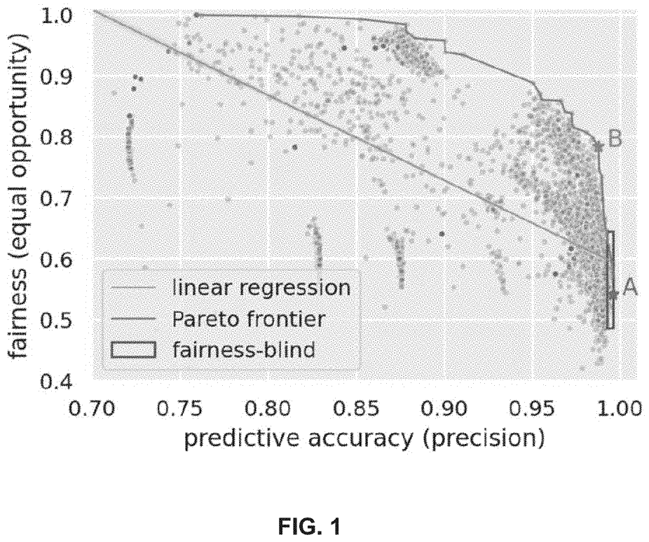

FIG. 1 illustrates an example of machine learning models and their associated fairness and performance. Each point represents an individual model and the respective model's fairness (defined as equal opportunity in this example) is plotted against its performance (specifically, predictive accuracy or precision in this example). Each model represented in the figure can be obtained in various ways including through bias reduction techniques, and each model can be trained with a different hyperparameter configuration. The trade-off between fairness and performance is also called the “fairness-performance trade-off.” This plot can be used to find the best possible fairness-performance trade-offs for the model search space for the dataset and its features being used. Bias can be introduced in many stages in a machine learning pipeline. The hyperparameter stage can be particularly suitable for reducing bias because it can control which model gets deployed.

A hyperparameter is any parameter used to tune a learning process for a machine learning model. Hyperparameters typically cannot be inferred during training, and the model's performance is seen as a function of these hyperparameters. Examples include the number of neurons in a feed-forward neural network (or its architecture), the number of estimator trees to use in a random forest predictor, whether or not to perform a specific pre-processing step on the training data, the choice of machine learning algorithm, or the like. Other examples of hyperparameters are further described herein.

A goal of hyperparameter optimization is to select hyperparameter values that perform well on a given black-box objective function. Conventional hyperparameter optimization and model selection processes are fairness-blind, solely optimizing for performance. By doing so, these methods unknowingly target models with low fairness (region marked with a rectangular box in FIG. 1). However, as shown by the plotted Pareto frontier, significant fairness improvements can be achieved at small performance costs. For instance, model B achieves 44.8% higher fairness than model A (the model with highest performance), at a cost of 0.8% decrease in performance, which is arguably a better trade-off. While current fairness-blind techniques target model A, the region of optimal fairness-performance trade-offs to which model B belongs can be targeted instead. A large spread is observed over the fairness metric at any level of performance, even within this fairness-blind region. Thus, it is possible to select fairer hyperparameter configurations without significant decreases in performance.

By making the hyperparameter search fairness-aware while maintaining resource-efficiency, program designers can adapt pre-existing operations to accommodate fairness with controllable extra cost and without significant implementation friction. The disclosed techniques find application in a variety of settings including fraud detection. Although the examples chiefly describe fraud detection (namely account opening fraud), this is merely exemplary and not intended to be limiting.

In various embodiments and as further described herein, hyperparameter tuners are extended to optimize for both performance and fairness through a weighted scalarization controlled by a parameter, e.g., a. As further described herein, a heuristic can be used to automatically find an adequate a value. Examples of hyperparameter tuners include:
Hyperband,
Random Search, and
Tree Parzen Estimator (TPE).

The disclosed techniques focus on Fairband, which is a fairness-aware variant of Hyperband. However, the disclosed techniques regarding applying an a parameter can also be extended to other types of hyperparameter tuners including Random Search and TPE.

Hyperband is an existing hyperparameter tuner that addresses the exploration vs. exploitation trade-off between (i) evaluating a larger number of configurations (n) on an averaged lower budget (B) per configuration (B/n) or (ii) evaluating a smaller number of configurations on an average higher budget. Hyperband splits the total budget into different instances of the trade-off, then calls successive halving (SH) as a subroutine for each one. Successive halving (1) uniformly allocates a budget for each iteration to a set of arms (hyperparameter configurations), (2) evaluates their performance, (3) discards the worst half, and repeats from step 1 until a single arm remains. Hyperband can be thought of as a grid search over feasible values of n. Hyperband takes two parameters R, the maximum amount of resources allocated to any single configuration; and η, the ratio of budget increase in each SH round (n=2 for the original SH). Each SH run, called a bracket, is parameterized by the number of sampled configurations n, and the minimum resource units allocated to any configuration r. The process features an outer loop that iterates over possible combinations of (n,r), and an inner loop that executes SH with the aforementioned parameters fixed. The outer loop is executed smax+1 times, where smax=└logη (R)┘. The execution of Hyperband takes a budget of (smax+1)*B.

Hyperparameter optimization is simultaneously model independent, metric independent, and already an intrinsic component in typical existing real-world machine learning pipelines. However, current bias reduction methods either (1) act on the input data and cannot guarantee fairness on the end model, (2) act on the model's training phase and can only be applied to specific model types and fairness metrics, or (3) act on a learned model's predictions thus being limited to act on a sub-optimal space and requiring test-time access to sensitive attributes. Therefore, by introducing fairness objectives on the hyperparameter optimization phase in an efficient way, the disclosed techniques help real-world practitioners to find optimal fairness-performance trade-offs in an easily pluggable manner, regardless of the underlying model type or bias reduction method.

Accommodating fairer practices can be challenging. For example, model-specific bias mitigation methods might not always comply with performance or business requirements. The disclosed techniques provide a seamless and flexible approach that allows decision-makers to have better control over selecting models that meet desired attributes such as having a desired performance-fairness trade-off, fulfilling the business, legal, or performance requirements, and the like.

Embodiments of bandit-based techniques for fairness-aware hyperparameter optimization are disclosed. In various embodiments, the disclosed techniques include a set of competitive fairness-aware hyperparameter optimization processes for multi-objective optimization (e.g., scalarization) of the fairness-performance trade-off that are agnostic to both the explored hyperparameter space and the objective metrics. In various embodiments, the disclosed techniques include a heuristic to automatically set the fairness-performance trade-off parameter. The disclosed techniques for promoting model fairness can be easily integrated with various machine learning pipelines (including existing/current pipelines) with minimal extra development or computational cost. In one aspect, the disclosed techniques can be used without changing operators used to generate a model, so the machine learning pipeline does not need to be changed. In another aspect, the disclosed techniques can be integrated with any type of learning algorithm (including standard off-the-shelf learning algorithms) and pre-processing methods.

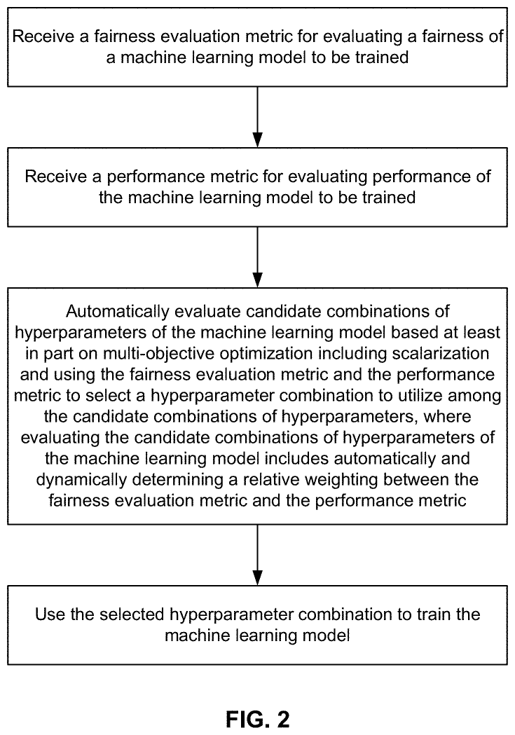

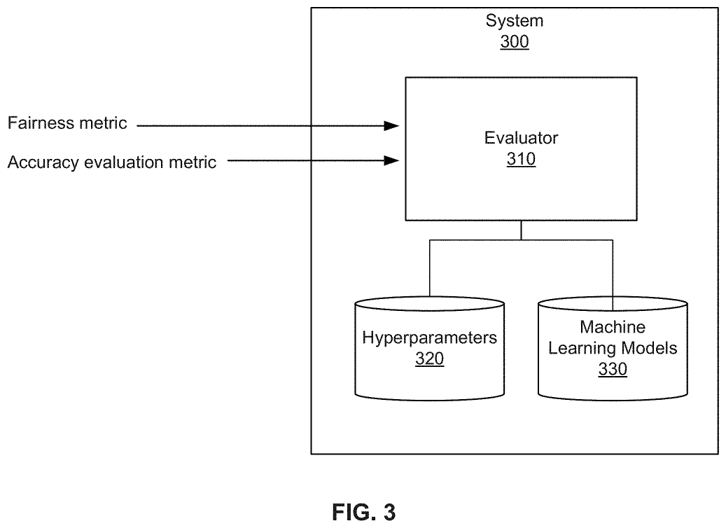

FIG. 2 is a flow diagram illustrating an embodiment of a process for fairness-aware hyperparameter optimization based on bandit-based techniques. This process may be implemented by system 300 of FIG. 3.

In the example shown, the process begins by receiving a fairness evaluation metric for evaluating fairness of a machine learning model to be trained (200). The fairness evaluation metric can be specified or defined by a user/stakeholder. The fairness evaluation metric can be provided in variety of ways such as received via a graphical user interface, loaded from a file, looked up in a database/user profile storage depending on the user case or user, etc. The fairness evaluation metric may vary depending on a use case. The disclosed techniques accommodate any fairness evaluation metric.

Fairness can be defined in a variety of ways and is domain dependent and subjective. Fairness in a given decision-making process may be defined as the lack of bias and prejudice. Fairness metrics can be subdivided as measuring group or individual fairness. Individual fairness measures the degree to which similar individuals are treated similarly, and is based on similarity metrics on the individuals' attributes. On the other hand, group fairness aims to measure disparate treatment between protected (or underprivileged) and unprotected (or privileged) groups (e.g., across different races, age groups, genders, or religions).

Some examples of fairness metrics include:
Demographic parity: the likelihood of a positive or negative outcome should be conditionally independent of whether the individual is in the protected group;
Disparate impact: the ratio between positive prediction rates between an underprivileged group and privileged group;
Equalized odds: balancing true positive rates and false positive rates across subgroups;
Equal opportunity: equal true positive rates across subgroups;
Accuracy equality: prediction accuracy should be equal across protected groups;
Balance for the positive class: the expected score for a positively classified individual is equal across groups; and
Balance for the negative class: the expected score for a negatively classified individual is equal across groups.

The machine learning model to be trained and for which fairness is evaluated may be one from among many selected to be evaluated. For example, the deployment of a model is preceded by a model selection stage where possibly hundreds or thousands of models are trained and evaluated under some predetermined performance metric (e.g., accuracy evaluation).

The process receives a performance metric for evaluating performance of the machine learning model to be trained (202). A performance metric can include any metric related to model performance such as an accuracy evaluation metric recall, precision, AUC (area under receiver operating characteristic curve), etc.

A model is considered to perform well when it generalizes well, meaning it can predict the correct output on previously unseen input data. There are various ways to measure model performance, and the choice of performance metric (e.g., accuracy) depends on the specific problem, its domain, and the possible real-world constraints it carries. A commonality among most metrics is that they are written as functions of a confusion matrix. A confusion matrix frames a model's predictions along dimensions of possible ground truth and predicted outcomes, summarizing the number of correct and incorrect predictions by class. In the case of a binary confusion matrix, the matrix is 2 by 2 and reports the number of true positives (TP; positive ground truth and predicted positive), false positives (FP; negative ground truth and predicted positive), false negatives (FN; positive ground truth and predicted negative), and true negatives (TN; negative ground truth and predicted negative), predicted positives (P), and predicted negatives (N).

A model can have an associated true positive rate (also known as sensitivity or recall), false negative rate, true negative rate, and false positive rate. An example of a metric is a specified recall at a specified false positive rate (e.g., recall at 3% false positive rate), and may be defined according to business requirements or the like. The precision of a model is defined as

$$\frac{TP}{TP + FP} ,$$

and the accuracy of a model is defined as

$$\frac{TP + TN}{P + N} ,$$

which is the percentage of correct predictions made. A model's performance is usually measured as one or a combination of the aforementioned metrics.

The process automatically evaluates candidate combinations of hyperparameters of the machine learning model based at least in part on multi-objective optimization including scalarization and using the fairness evaluation metric and the performance metric to select a hyperparameter combination to utilize among the candidate combinations of hyperparameters, wherein evaluating the candidate combinations of hyperparameters of the machine learning model includes automatically and dynamically determining a relative weighting between the fairness evaluation metric and the performance metric (204). The combinations of hyperparameters are also sometimes referred to as hyperparameter configurations.

In various embodiments, joint maximization of fairness and performance is a multi-objective optimization problem, defined by Equation (1).

$${arg max}_{λ ∈ Λ} G ( λ ) = ( a ( λ ) , f ( λ ) ) \qquad ( 1 )$$

where G(λ) is a goal function, λ is a hyperparameter configuration drawn from the hyperparameter space Λ, a: Θ→[0, 1] is the performance metric (received at 202), and f: Λ→[0, 1] is the fairness evaluation metric (received at 200; sometimes simply called a “fairness metric”). In this context, there is a set of Pareto optimal solutions rather than a single optimal solution. A solution λ* is Pareto optimal if no other solution improves on an objective without sacrificing another objective. The set of all Pareto optimal solutions is referred to as the Pareto frontier (an example of which is shown in FIG. 1).

Multi-objective optimization approaches generally rely on either Pareto-dominance methods or decomposition methods (decomposition and/or scalarization is generally referred to as “scalarization” herein). The former uses Pareto-dominance relations to impose a partial ordering in the population of solutions. However, the number of incomparable solutions can quickly dominate the size of the population (the number of sampled hyperparameter configurations). This is further exacerbated for high-dimensional problems. On the other hand, decomposition-based methods employ a scalarizing function to reduce all objectives to a single scalar output, inducing a total ordering over all possible solutions. One option is the weighted lp-norm shown in Equation (2).

$${arg max}_{λ ∈ Λ} {‖ H ( λ ) ‖}_{p} = {( {\sum }_{i = 1}^{k} {w}_{i} {{h}_{i} ( λ )}^{p} )}^{\frac{1}{p}} \qquad ( 2 )$$

where the weights vector w induces an a priori preference over the objectives. hi(λ) is each objective, which in this example is f(λ) and a(λ) from Equation (1).

Conventional multi-objective optimization is difficult to apply at scale. However, because the Pareto frontier geometry in this context is most often convex (as shown in FIG. 1), a decomposition-based method can be used. This type of method typically converges faster, and effectively targets solutions on the Pareto frontier. All Pareto optimal solutions of a convex problem can be obtained by varying the weights vector w. In various embodiments, the l1-norm can be used, carrying the same performance guarantees as using p>1 for convex problems. Thus, an optimization metric g is defined by Equation (3).

g(λ)=∥G(λ)∥₁ (3)

In various embodiments, only two goals are optimized, so the a parameter can be defined by Equation (4) and the optimization metric g can be defined by Equation (5), without loss of generality:

α=w₁=1−w₂ (4)

g(λ)=α·a(λ)+(1+α)·f(λ) (5)

where w₁=α is the relative importance of model performance, and w₂=1−α is the relative importance of fairness. In other words, a defines a relative weighting between the fairness evaluation metric and the performance metric. This simplifies an objective of the process to finding the hyperparameter configuration A from a pre-defined hyperparameter search space A that maximizes the scalar objective function g(A) as represented by Equation (6):

$${arg max}_{λ ∈ Λ} g ( λ ) \qquad ( 6 )$$

The objective represented by Equation (6) can be implemented by evaluating machine learning models in both fairness and performance metrics on a holdout validation set. Computing fairness does not incur significant extra computational cost, as it is based on substantially the same predictions used to estimate performance. Additionally, readily available fairness off-the-shelf assessment libraries may be used.

In order to find target solutions, the weighting parameter is varied α ∈ [0, 1]. Nonetheless, a may indicate some predefined objective preference. For instance, in a punitive machine learning setting, an organization may decide it is willing to spend a predefined amount (e.g., x$) for each removed false positive case in the underprivileged class, thereby defining an explicit fairness-performance trade-off. If no specific trade-off arises from domain knowledge beforehand, then the set of all Pareto optimal models can be displayed, and the decision on which trade-off to employ would be left to the model's stakeholders.

In various embodiments, a heuristic for dynamically setting the value of a enables a complete out-of-the-box experience without the need for specific domain knowledge. There can be various objectives for setting the heuristic. For example, first, eliminate a hyperparameter that would need specific domain knowledge to be set; and second, promote a wider exploration of the Pareto frontier and a larger variability within the sampled hyperparameter configurations.

The α values guide the search towards different regions of the fairness-performance trade-off, so processing can be improved by efficiently exploring the Pareto frontier in order to find a comprehensive selection of balanced trade-offs. As such, if currently explored trade-offs correspond to high performance (above a first threshold) but low fairness (below a second threshold), the search can be guided towards regions of higher fairness (by choosing a lower α). Conversely, if currently explored trade-offs correspond to high fairness but low performance, the search can be guided towards regions of higher performance (by choosing a higher α). In other words, the search can be guided to minimize the difference between average fairness and average performance.

To achieve the aforementioned balance, a proxy-metric of the target direction of change is used. This direction is given by the difference, δ, between the expected model fairness, E_{π∈D}[f (λ)]=f, and the expected model performance, E_{λ∈D}[α(λ)]=a as shown in Equation (7).

δ=f̅−ā, δ ∈ [−1,1] (7)

Expected values are measured as the mean of respective metric over the sample of hyperparameter configurations, D ⊆ A.

Hence, when this difference is negative (f<a), the models sampled thus far tend towards better-performing but unfairer regions of the hyperparameter space. Consequently, decreasing a directs the search towards fairer configurations. Conversely, when this difference is positive (f>a), increasing a directs the search towards better-performing configurations.

This change in a can be made proportional to 6 by some constant k>0, such that:

$$\frac{d α}{d δ} = k , k ∈ {ℝ}^{+} \qquad ( 8 )$$

which is equivalent to:

α=k·δ+c, c ∈ [symbol] (9)

with c being the constant of integration. Given that δ∈ [−1, 1], and together with the constraint that α ∈[0, 1], the feasible values for k and c are k=0.5 and c=0.5. Thus, the computation of dynamic-a is given by:

α=0.5·(f̅−ā)+0.5 (10)

Earlier iterations are expected to have lower performance (as these are trained on a lower budget), while later iterations are expected to have higher performance. By computing new values of α at each Fairband iteration, a dynamic balance is promoted between these metrics as the search progresses. Over time (iterations), the difference between average fairness and average performance can be minimized. For example, more importance can be given to performance on earlier iterations but continuously moving importance to fairness as performance increases (a natural side-effect of increasing training budget) or vice versa.

In embodiments in which α is static (Fairband with static α), a target trade-off, α, has already been chosen for the method's search phase, and this trade-off is also employed for model selection (selection-α). In other embodiments, (referred to as FB-auto variant of Fairband), aiming for an automated balance between both metrics, the same strategy is employed for setting a as that used during search. By doing so, the weight of each metric is selected based on an approximation of their true range instead of blindly applying a pre-determined weight. For instance, if the distribution of fairness is in range f E [0, 0.9] but that of performance is in range a E [0, 0.3], then a balance could be achieved by weighing performance higher, as each unit increase in performance represents a more significant relative change (this mechanism is achieved by Equation 10). However, at this stage, information can be used from all brackets, as promoting exploration of the search space is no longer desired. Instead, an objective at this stage may be a consistent and stable model selection. Thus, for FB-auto, the selection-a is chosen from the average fairness and performance of all sampled configurations.

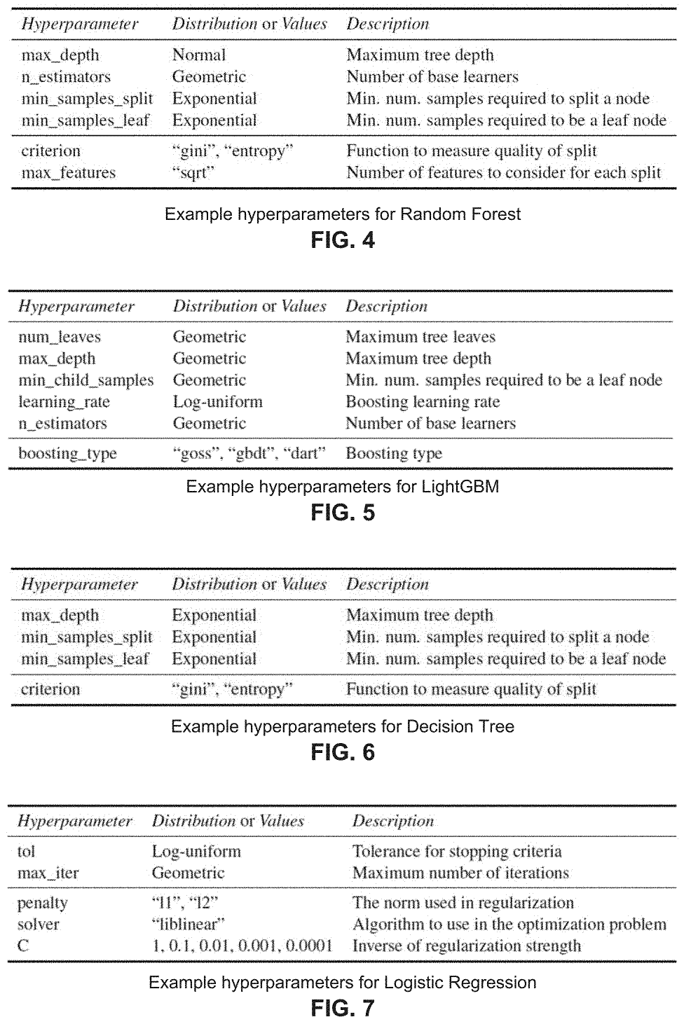

Examples of candidate hyperparameters of the machine learning model are shown in FIGS. 4-7.

The process uses the selected hyperparameter combination to train the machine learning model (206). The selected hyperparameter combination causes the machine learning model to perform better (e.g., optimized) compared to a model that does not use the hyperparameter combination because the model balances fairness and performance.

The hyperparameter combination/configuration can be output in a variety of ways. A result of the process of FIG. 2 (which can be thought of as a multi-objective optimization task) is a collection of hyperparameter configurations that represent the fairness-performance trade-off. This information can be output as a plot of all available choices on the fairness-performance space. A specific trade-off can be manually or automatically selected according to objectives such as business constraints or legislation/regulations. As further described with respect to FIG. 3, in other embodiments, the objectives of a user or organization can be determined (looked up from a user profile for example), and one or more hyperparameter combinations that meet the objectives can be output.

In various embodiments, the process includes outputting a sorted set of one or more machine learning models trained using the selected hyperparameter combination.

FIG. 3 is a block diagram illustrating an embodiment of a system for bandit-based techniques for fairness-aware hyperparameter optimization. System 300 can be any type of system. For purposes of illustration, system 300 is a fraud detection system, but this is merely exemplary and not intended to be limiting. System 300 includes evaluator 310, hyperparameter store 320, and machine learning model store 330.

Evaluator 310 is configured to perform the process of FIG. 2 to select a hyperparameter combination for a machine learning model. In various embodiments, evaluator 310 receives a fairness evaluation metric and a performance metric as shown. Evaluator 310 evaluates candidate combinations of hyperparameters of the machine learning model (stored in hyperparameter store 320) using the fairness evaluation metric and the performance metric to select a hyperparameter combination to utilize among the candidate combinations of hyperparameters. Evaluator 310 can evaluate candidate combinations of hyperparameters for various machine learning models, which may be stored in machine learning model store 330. Evaluator 310 automatically and dynamically determining a relative weighting between the fairness evaluation metric and the performance metric, which is used to select a hyperparameter combination for a machine learning model.

Evaluator 310 may also be configured to perform the process of FIG. 2 while taking into account user preferences. Referring again to the punitive machine learning setting in which an organization (user) decides it is willing to spend a predefined amount (e.g., x$) for each individual less false positive in the underprivileged class, evaluator 310 outputs one or more selected hyperparameters that meet this explicit criterion. Otherwise, if no specific trade-off arises from domain knowledge beforehand, then evaluator 310 outputs the set of all Pareto optimal models (which can be displayed in a graphical user interface), and the decision on which trade-off to employ would be left to the model's stakeholders.

Although hyperparameter store 320 and machine learning model store 330 are shown as local to system 300, in various embodiments one or the other or both may be located remotely.

FIGS. 4-7 show some examples of hyperparameters used for various model types. More specifically, FIG. 4 shows an example of hyperparameters used for a Random Forest model. FIG. 5 shows an example of hyperparameters used for a LightGBM model. FIG. 6 shows an example of hyperparameters used for a Decision Tree model. FIG. 7 shows an example of hyperparameters used for a Logistic Regression model.

In various embodiments, model types (in this example there are four model types: Random Forest, Decision Tree, Logistic Regression, and LightGBM) are fed to the machine learning pipeline framework by specifying the class-path on a YAML configuration file. A hyperparameter is represented by the model's class-path, and is uniformly sampled between all choices: Random Forest, Decision Tree, Logistic Regression, and LightGBM. Since the models used can vary from application to application, the disclosed techniques can easily be adapted to the set of models used by a particular application or stakeholder and this example of four model types is merely exemplary and not intended to be limiting.

The disclosed techniques are compatible with various hyperparameter tuners. The best-suited choice of hyperparameter tuner depends on the task at hand. Random Search (RS) is typically the most flexible, carries the least assumptions on the optimization metric, and converges to the optimum as budget increases. Tree Parzen Estimator (TPE) improves convergence speed by attempting to sample only useful regions of hyperparameter space. Bandit-based methods (e.g., Successive Halving, Hyperband) are resource-aware, and thus have strong anytime performance, often being the most efficient when under budget constraints.

The disclosed techniques extend three popular hyperparameter tuners to optimize for fairness through a weighted scalarization controlled by an a parameter (in various embodiments, default α=0.5). The fairness-aware variants for RS, TPE, and Hyperband, are respectively referred to as FairRS, FairTPE, and Fairband. All of these variants can be easily incorporated in existing machine learning pipelines at minimal cost.

Fairband inherently benefits from resource-aware methods' advantages: efficient resource usage, trivial parallelization, as well as being both model- and metric-agnostic. Furthermore, bandit-based methods are highly exploratory and therefore prone to inspect broader regions of the hyperparameter space. For instance, experiments show that Hyperband evaluates approximately six times more configurations than RS with the same budget.

By employing a weighted scalarization technique in a bandit-based setting, if model ma represents a better fairness-performance trade-off than model mb with a short training budget, then this distinction is likely to be maintained with a higher training budget. Thus, by selecting models based on both fairness and performance, the disclosed techniques guide the search towards fairer and better performing models. These low-fidelity estimates of future metrics on lower budget sizes is one aspect that drives the efficiency of bandit-based methods' (e.g., Hyperband and Successive Halving) in hyperparameter search.

Experiments were conducted using a real-world bank account opening fraud detection problem. In account opening fraud, a malicious actor will attempt to open a new bank account using a stolen or synthetic identity (or both), in order to quickly max out its line of credit. When developing machine learning models to detect fraud, banks optimize for a single metric of performance (e.g., fraud recall). However, as shown in experiments, the models with highest fraud recall have disparate false positive rates on specific groups of applicants. This means that the machine learning models are exhibiting bias because the ability for a legitimate individual to open a bank account is important for economic well-being, and preventing specific groups from opening bank accounts is problematic. By applying the disclosed techniques, models were found with at least 95% to 111% improved fairness with just 6% drop in fraud recall when compared to the model with highest fraud recall obtained through standard hyperparameter optimization methods.

The disclosed bandit-based techniques for fairness-aware hyperparameter optimization have many advantages over conventional algorithmic fairness techniques. In one aspect, methods such as fair Bayesian Optimization use constraints and set values for the constraint, which is relatively opaque to a user because the user does not know if a constraint can be met. In another aspect, such methods are typically not multi-objective, meaning they are unable to find trade-offs between models (e.g., they cannot generate a plot such as the one shown in FIG. 1). By contrast, the disclosed techniques find the best models given various constraints and enable decision makers to make more informed decisions. In yet another aspect, such methods typically do not work with categorical hyperparameters and are limited to floating point numbers such as the learning rate. By contrast, the disclosed techniques, which are based on Hyperband, can handle any parameter including those that are not floating point numbers.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a fairness evaluation metric for evaluating a fairness of a machine learning model to be trained;
receiving a performance metric for evaluating performance of the machine learning model to be trained;
automatically evaluating candidate combinations of hyperparameters of the machine learning model based at least in part on multi-objective optimization including scalarization and using the fairness evaluation metric and the performance metric to select a hyperparameter combination to utilize among the candidate combinations of hyperparameters, wherein evaluating the candidate combinations of hyperparameters of the machine learning model includes automatically and dynamically determining a relative weighting between the fairness evaluation metric and the performance metric; and
using the selected hyperparameter combination to train the machine learning model.

2. The method of claim 1, wherein the scalarization reduces objectives of the multi-objective optimization to a single scalar output and includes a weighted lp-norm.

3. The method of claim 1, wherein the fairness evaluation metric includes a measure of at least one of: group fairness.

4. The method of claim 1, wherein the performance metric includes a measure of performance of a predictive task.

5. The method of claim 1, wherein the selected hyperparameter combination is included in a Pareto frontier.

6. The method of claim 1, wherein (i) a weighting of the fairness evaluation metric is inversely proportional and (ii) a weighting of the performance metric, sums to 1.

7. The method of claim 1, further comprising evaluating the fairness of the machine learning model to be trained according to the fairness evaluation metric, wherein the evaluation of the fairness of the machine learning model to be trained is based on substantially the same predictions used to evaluate the performance of the machine learning model to be trained.

8. The method of claim 1, wherein the dynamic determination of the relative weighting between the fairness evaluation metric and the performance metric is based on a user-defined fairness-performance trade-off.

9. The method of claim 1, further comprising outputting a sorted set of one or more machine learning models trained using the selected hyperparameter combination.

10. The method of claim 9, wherein the set of one or more machine learning models are output to a graphical user interface including by at least one of:
displaying an associated fairness and performance for each of the one or more machine learning models; or
displaying at least one comparison between machine learning models in the set of one or more machine learning models, wherein the machine learning models meet at least one Pareto criterion.

11. The method of claim 1, wherein the dynamic determination of the relative weighting between the fairness evaluation metric and the performance metric is performed automatically and does not require specific domain knowledge.

12. The method of claim 1, wherein the dynamic determination of the relative weighting between the fairness evaluation metric and the performance metric includes guiding a search towards minimizing a difference between average fairness and average performance.

13. The method of claim 1, wherein the dynamic determination of the relative weighting between the fairness evaluation metric and the performance metric includes guiding a search towards regions of higher fairness if current candidate combinations of hyperparameters correspond to machine learning model performance above a first threshold and machine learning model fairness below a second threshold.

14. The method of claim 1, wherein the dynamic determination of the relative weighting between the fairness evaluation metric and the performance metric includes determining an updated weighting for the fairness evaluation metric and an updated weighting for the performance metric in each iteration.

15. The method of claim 14, wherein at least one of:
the updated weighting of the fairness evaluation metric at a current iteration is increased relative to that of a previous iteration if at least one of:
an average fairness of the evaluated candidate combinations of hyperparameters decreased in the previous iteration, or
an average performance of the evaluated candidate combinations of hyperparameters increased in the previous iteration; or
the updated weighting of the performance metric at a current iteration is increased relative to that of a previous iteration if at least one of:
an average fairness of the evaluated candidate combinations of hyperparameters increased in the previous iteration, or
an average performance of the evaluated candidate combinations of hyperparameters decreased in the previous iteration.

16. The method of claim 14, wherein the updated weighting of at least one of the fairness evaluation metric and the updated weighting of the performance metric at a current iteration is determined based least in part on an average fairness and an average performance of already trained hyperparameter combinations.

17. The method of claim 1, wherein the dynamic determination of the relative weighting between the fairness evaluation metric and the performance metric includes determining a weighting for the fairness evaluation metric based on an associated range of values for the fairness evaluation metric and a weighting for the performance metric based on an associated range of values for the performance metric.

18. The method of claim 1, wherein the use of the selected hyperparameter combination to optimize the machine learning model to be trained includes selecting the machine learning model based at least in part on an average fairness and performance of all sampled hyperparameter combinations.

19. A system, comprising:
a processor configured to:
receive a fairness evaluation metric for evaluating a fairness of a machine learning model to be trained;
receive a performance metric for evaluating performance of the machine learning model to be trained;
automatically evaluate candidate combinations of hyperparameters of the machine learning model based at least in part on multi-objective optimization including scalarization and using the fairness evaluation metric and the performance metric to select a hyperparameter combination to utilize among the candidate combinations of hyperparameters, wherein evaluating the candidate combinations of hyperparameters of the machine learning model includes automatically and dynamically determining a relative weighting between the fairness evaluation metric and the performance metric; and
use the selected hyperparameter combination to train the machine learning model; and
a memory coupled to the processor and configured to provide the processor with instructions.

20. A computer program product embodied in a non-transitory computer readable medium and comprising computer instructions for:
receiving a fairness evaluation metric for evaluating a fairness of a machine learning model to be trained;
receiving a performance metric for evaluating performance of the machine learning model to be trained;
automatically evaluating candidate combinations of hyperparameters of the machine learning model based at least in part on multi-objective optimization including scalarization and using the fairness evaluation metric and the performance metric to select a hyperparameter combination to utilize among the candidate combinations of hyperparameters, wherein evaluating the candidate combinations of hyperparameters of the machine learning model includes automatically and dynamically determining a relative weighting between the fairness evaluation metric and the performance metric; and
using the selected hyperparameter combination to train the machine learning model.
